(19) United States
(12) Patent Application Publication
(10) Pub. No.: US 2022/0289271 A1
(43) Pub. Date: Sep. 15, 2022

(54) Fly-By-Wire Steering System with Position Detector

(71) Applicant: Atlis Motor Vehicles, Inc., Mesa, AZ (US)

(72) Inventors: Mark Hanchett, Mesa, AZ (US); Kamal Wolly, Tempe, AZ (US)

(73) Assignee: Atlis Motor Vehicles, Inc., Mesa, AZ (US)

(21) Appl. No.: 17/831,697

(22) Filed: Jun. 3, 2022

Related U.S. Application Data
(60) Provisional application No. 63/216,560, filed on Jun. 30, 2021.

(51) Int. Cl. B62D 5/04; B62D 3/12

(52) U.S. Cl. CPC B62D 5/0406; B62D 5/0421; B62D 3/12; B62D 5/0481

(57) ABSTRACT

A fly-by-wire steering system uses one or more magnets and one or more magnetic sensors to determine the position the rack of the steering system. The magnetic sensors provide a high-level signal when proximate to magnet. The signals from magnetic sensors provide an indication of the position of the rack. The sequence of changing values of the signals magnetic sensors provides an indication of the direction of travel of the rack. The signals may be used to calibrate a steering sensor and/or an actuator.

### BACKGROUND

Embodiments of the present invention relate to steering systems for a vehicle.

Most steering systems for vehicles today include a steering wheel, a steering column and some form of rack and pinion mechanism. The steering column mechanically connects the steering wheel to the pinion. The mechanical connection between the steering wheel and the rack and pinion mechanically relates the position of the steering wheel to the position of the rack. For example, in most vehicles, the steering wheel is oriented in a particular position when the rack is centered with respect to its potential direction of travel.

When a mechanical steering system is replaced with a fly-by-wire steering system, the mechanical connection between the steering wheel and the rack is lost, so it is difficult for the steering system to know when the rack is centered. Fly-by-wire steering systems would benefit from a system for detecting when the rack is positioned in the center position. Further, a steering system would benefit from being able to determine the direction of movement of the rack.

### SUMMARY

An example embodiment of a steering system includes one or more magnets and one or more magnetic sensors. The magnets and magnetic sensors are positioned with respect to the rack so that as the rack moves, the magnetic sensors provide information as to when the rack is centered and/or the direction of movement of the rack.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a perspective view of a mechanical steering system.

FIG. 2 is a perspective view of an example embodiment of a fly-by-wire steering system of the present disclosure.

FIG. 3 is a front view of the example embodiment with a diagram of the signals from the magnetic sensors while the rack is in a central position.

FIG. 4 is the front view of the example embodiment with a diagram of the signals from the magnetic sensors while the rack is positioned leftward of the central position.

FIG. 5 is the front view of the example embodiment with a diagram of the signals from the magnetic sensors while the rack is positioned at the leftmost position.

FIG. 6 is the front view of the example embodiment with a diagram of the signals from the magnetic sensors while the rack is positioned rightward of the central position.

FIG. 7 is the front view of the example embodiment with a diagram of the signals from the magnetic sensors while the rack is positioned at the rightmost position.

FIG. 8 is a diagram of the signals from the magnetic sensors for a variety of movements of the steering wheel.

FIG. 9 is a table of the digital equivalent values of the signals from the magnetic sensors for the variety of movements of the steering wheel.

### DETAILED DESCRIPTION

### Overview

An example embodiment of the present disclosure relates to a fly-by-wire steering system 200 for a vehicle. The term fly-by-wire refers to a steering system in which some mechanical components of the steering system have been replaced by electronic and/or electromechanical components that are controlled and/or monitored by a processing circuit (e.g., computer). In an example embodiment, the fly-by-wire steering system 200 includes a processing circuit 240, a memory 250, magnetic sensors 212, 222, 232, a steering sensor 260 and an actuator 270.

Data regarding rotation of the steering wheel 102 is provided by steering sensor 260. The data is sent by a wired or wireless communication link to the processing circuit 240. The processing circuit uses the data from the steering sensor 260 to control the actuator 270 via a wired or wireless communication link. The actuator 270 controls the orientation of the tires, using a rack 108 and pinion 106, in accordance with the data from the steering sensor 260. One or more magnets (e.g., 210, 220, 230) are positioned on the rack and one or more respective magnetic sensors (e.g., 212, 222, 232) are positioned on the vehicle. As the rack 108 moves to orient the wheels 120, the magnetic sensors detect the magnets. The magnetic sensors report data with respect to detecting the magnets to the processing circuit 240 via a wired or wireless communication link. In an example embodiment that includes a single magnet (e.g., 230) and a single magnetic sensor (e.g., 232), the processing circuit 240 uses the data from the magnetic sensor 232 to determine when the rack 108 is centered with respect to the pinion 106 and/or the magnetic sensor 232. In another example embodiment that includes three or more magnetic sensors (e.g., 212, 222, 232), the processing circuit 240 uses the data from the magnetic sensors to determine when the rack 108 is centered with respect to the pinion 106 and the direction of movement of the rack 108. Sensing the direction of movement of the rack 108 provides information regarding whether the wheels are orienting (e.g., turning) to the left or to the right of center (e.g., straight ahead). The position of the magnets may be interchanged with the position of the magnetic sensors, so that the magnetic sensors are mounted on the rack 108 and the magnets with respect to the vehicle or any combination thereof.

### Rack and Pinion

A rack and pinion mechanism for orienting the tires is used for comprehension of the present disclosure. Although the example embodiments discussed herein are described with respect to the rack and pinion mechanism, the concepts regarding the magnets and the magnetic sensors for detecting the orientation and/or direction of changing orientation of the tires is applicable to any mechanism that orients tires.

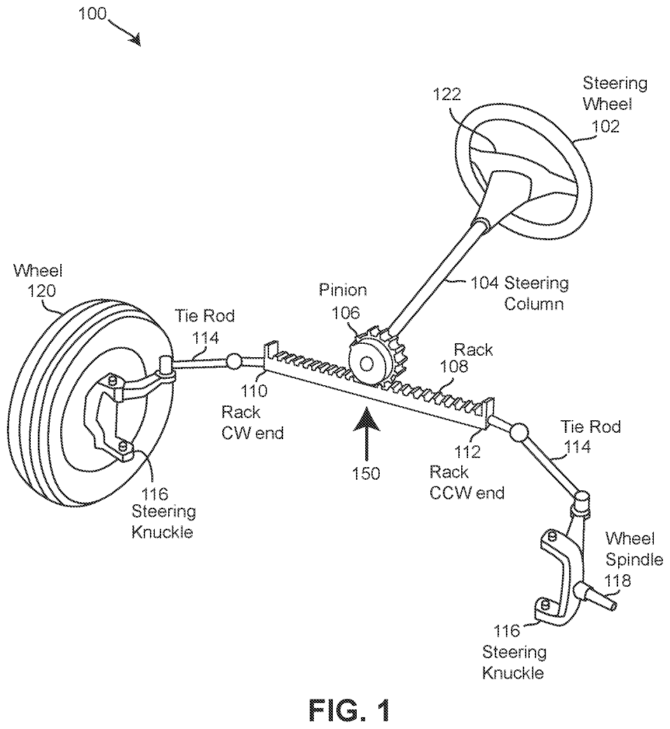

The mechanical steering system 100 that uses a rack 108 and a pinion 106 is shown in FIG. 1. In the mechanical steering system 100, the steering wheel 102 is connected to the steering column 104 which is connected to the pinion 106. As the steering wheel 102 turns (e.g., rotates), the steering column 104 turns, which in turn rotates the pinion 106. The position of the pinion 106 is fixed at a position indicated by an arrow 150 in FIGS. 1-7. The rack 108 moves relative to the pinion 106, or in other words relative to the arrow 150. The pinion 106 does not move with respect to the arrow 150. The pinion 106 rotates while remaining at the position indicated by the arrow 150. The rack 108 moves leftward and rightward with respect to the pinion 106 responsive to rotation of the pinion 106. The rack 108 has a center point (e.g., central, midpoint). When the rack 108 is positioned in a central position, as best seen in FIGS. 1-3, the midpoint of the rack aligns with the pinion 106 and with the arrow 150. While the rack 108 is positioned in the central position, the wheels 120 point forward, not turned to the left or the right, so that the vehicle travels along a straight line.

As the pinion 106 turns, it moves rack 108 to the left (e.g., leftward) and to the right (e.g., rightward) with respect to the arrow 150. As the steering wheel 102 is turned counterclockwise orient right from the perspective of the driver (e.g., pinion 106 turns clockwise in FIGS. 1-7), the rack 108 moves leftward, with respect to arrow 150, so that the rack CCW end 112 moves toward the pinion 106. As the rack 108 moves leftward, the wheels 120 move to the left so that the vehicle travels to the left (e.g., left-hand turn). As the steering wheel 102 is turned clockwise from the perspective of the driver (e.g., pinion 106 turns counterclockwise in FIGS. 1-7), the rack 108 moves rightward, with respect to arrow 150, so that the rack CW end 110 moves toward the pinion 106. As the rack 108 moves rightward, the wheels 120 move to the right so that the vehicle travels to the right (e.g., right-hand turn).

As the rack 108 moves, the tie rods 114 turn the steering knuckles 116 to position the wheel spindles 118, and therefore the wheels 120. While the pinion 106 is positioned in the center of the rack 108, the horizontal bar 122 across the steering wheel 102 is positioned horizontally, thereby informing the driver that the vehicle should be traveling straight forward unless the steering wheel 102 has rotated 360 degrees while making a hard turn.

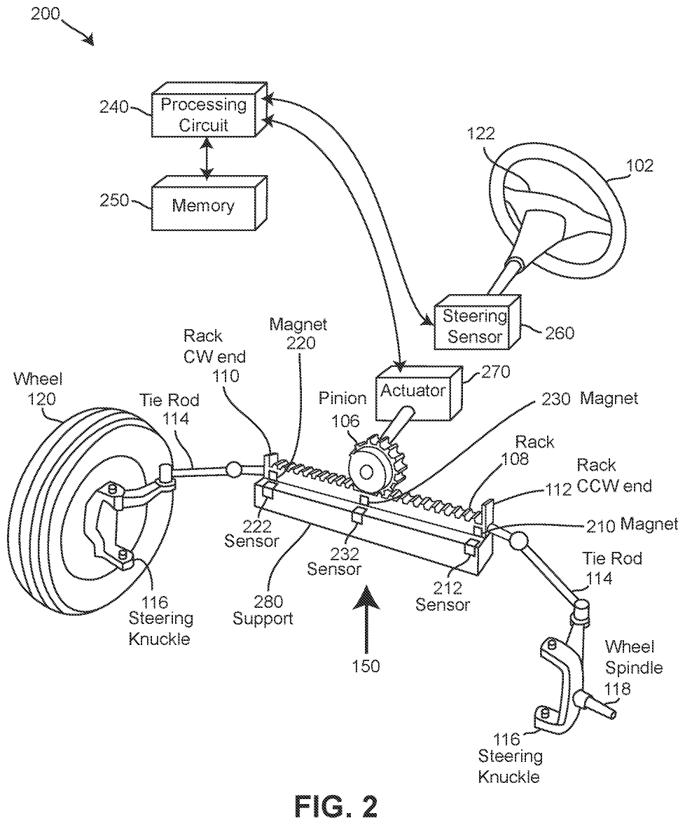

The fly-by-wire steering system 200, in accordance with the example embodiment of the present disclosure, is shown in FIG. 2. The fly-by-wire steering system 200 includes the steering wheel 102, the pinion 106, the rack 108, the tie rods 114, the steering knuckles 116, the wheel spindles 118 and the wheels 120, as does the mechanical steering system 100. However, the fly-by-wire steering system 200 does not include the steering column 104. The fly-by-wire steering system 200 includes the steering sensor 260, the actuator 270, the processing circuit 240, the memory 250, the support 280, magnets (e.g., 210, 220, 230) and magnetic sensors (e.g., 212, 222, 232). A first example embodiment of the fly-by-wire steering system 200 includes the magnet 230 and the magnetic sensor 232. A second example embodiment of the fly-by-wire steering system 200 includes the magnet 210, the magnet 220, the magnet 230, the magnetic sensor 212, the magnetic sensor 222, and the magnetic sensor 232.

The support 280 is adapted to be positioned with respect to the vehicle. The support 280 is adapted to be coupled to the vehicle. The support 280 is adapted to be positioned proximate to the rack 108. The support 280 is further adapted to be positioned with respect to the central position of the rack 108 and the pinion 106. The support 280 is adapted to be stationary, so as the rack 108 moves with respect to the support 280. The support 280 acts as a reference to the position of the rack 108.

In an example embodiment, the one or more magnets (e.g., 210, 220 230) are adapted to be coupled to the rack 108. The one or more magnetic sensors (e.g., 212, 222, 232) are adapted to be coupled to the support 280. The one or more magnets are adapted to be positioned along a length of the rack 108. The one or more magnetic sensors are adapted to be positioned along a length of the support 280. In another example embodiment, the one or more magnets are adapted to be coupled to the support 280. The one or more magnetic sensors are adapted to be coupled to the rack 108. The one or more magnets are adapted to be positioned along the length of the support 280 and the magnetic sensors are adapted to be positioned along the length of the rack 108. Positioning the magnets along the length of the rack 108 or the support 280 and the magnetic sensors along the length of the support 280 or the rack 108 respectively positions the magnets with respect to the magnetic sensors. Because the magnets are positioned with respect to the magnetic sensors and the support 280 is fixed with respect to the movement of the rack 108, the magnets and the magnetic sensors may be used to detect the position of the rack 108 with respect to the support 280. Knowing the position of the rack 108 with respect to the support 280 enables the processing circuit 240 to determine the position of the rack 108 with respect to the pinion 106.

In the example embodiments discussed herein, the number of magnets corresponds to the number of magnetic sensors; however, there may be more magnets the magnetic sensors or more magnetic sensors than magnets. As the number of magnets and magnetic sensors increases, the granularity of positions detectable by the processing circuit 240 decreases. In other words, if there are more magnets and more magnetic sensors, the processing circuit 240 can detect smaller movements of the rack 108.

### Steering Sensor

The steering sensor 260 detects the rotation and/or position of the steering wheel 102 and converts the detected rotation and/or position of the steering wheel 102 into data that describes the rotation and/or position of the steering wheel 102. The steering sensor 260 may detect the direction of rotation (e.g., clockwise, counterclockwise), the speed of rotation, and/or the position of the steering wheel 102 with respect to a fixed reference.

The information regarding the rotation and/or position of the steering wheel 102 may be converted into data in any manner. Any manner of encoding may be used to create the data that describes the rotation and/or position of the steering wheel 102. The processing circuit 240 may receive the data from the steering sensor 260. The processing circuit 240 may use the data from the steering sensor 260 to determine the position (e.g., degrees of rotation), rate of rotation and/or the direction of rotation of the steering wheel 102.

### Actuator

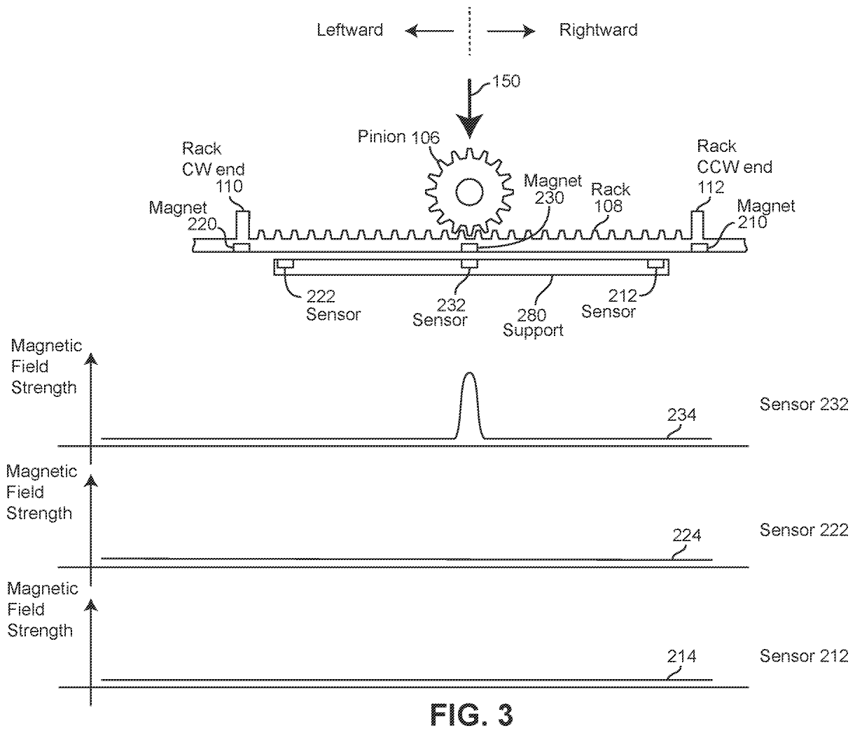

The actuator 270 controls the rotation of the pinion 106 and thereby the position of the rack 108. The actuator 270 may rotate the pinion 106 in a counterclockwise direction, from the perspective of the driver (e.g., pinion rotates clockwise in FIGS. 3-7), to move the rack CCW end 112 toward the pinion 106 (e.g., rack 108 moves leftward as shown in FIGS. 3-7). The actuator 270 may rotate the pinion 106 in a clockwise direction, from the perspective of the driver (e.g., pinion rotates counterclockwise in FIGS. 3-7), to move the rack CW end 110 toward the pinion 106 (e.g., rack 108 moves rightward as shown in FIGS. 3 and 6-7).

The actuator 270 is controlled by the processing circuit 240. The processing circuit 240 controls the actuator 270 in accordance with the data received from the steering sensor 260. As the steering wheel 102 is rotated in the clockwise direction, from the perspective of the driver, processing circuit 240 instructs the actuator 270 to rotate the pinion 106 in the clockwise direction, from the perspective of the driver (e.g., pinion rotates counterclockwise in FIGS. 3-7), to move the rack 108 rightward to move the rack CW end 110 closer to the pinion 106. As the steering wheel 102 is rotated in the counterclockwise direction, from the perspective of the driver, processing circuit 240 instructs the actuator 272 to rotate in the counterclockwise direction, from the perspective of the driver to move the rack 108 leftward to move rack CCW end 112 closer to the pinion 106. If the data from the steering sensor 260 shows that the steering wheel 102 has stopped rotating, the processing circuit 240 instructs the actuator 272 stop rotating so that the current position of the rack 108 is maintained. The processing circuit 240 may control the rate at which the actuator 270 rotates the pinion 106 so that rotation of the actuator 270 and thereby the rotation of the pinion 106 relates to the rate of rotation of the steering wheel 102.

The processing circuit 240 may also change the steering ratio at any time, under any circumstances and/or in response to the operating mode of the vehicle. In an example embodiment, the processing circuit 240 changes the steering ratio by increasing the number of rotations of the pinion 106 for each rotation of the steering wheel 102. In another example embodiment, the processing circuit changes to steering ratio by decreasing the number of rotations of the pinion 106 for each rotation of the steering wheel 102.

As discussed above, the fly-by-wire steering system 200 disclosed herein is not limited to use with a mechanical rack and pinion system. The processing circuit 240 may use the data from the steering sensor 260 to control one or more actuators 270 using any mechanical mechanisms to orient the wheels 120. Each wheel may oriented by a separate actuator 270.

### Magnetic Sensors

The magnetic sensors (e.g., 212, 222, 232) include any sensor capable of detecting a magnetic field and providing data responsive to detecting. The magnetic sensors may detect a magnetic flux, a strength of the magnetic field and/or the direction of a magnetic field. The magnetic sensors may include Hall sensors, ferromagnetic magneto resistors, semiconducting magneto resistors, ferromagnetic magneto resistors, flux gate sensors, resident sensors, induction magnetometers, eddy current sensors, variable reluctance sensors, magnetic encoders, reed contacts, magnetic force and torque sensors, magnetic flowmeters, any other type of conventional magnetic sensor and/or any combination thereof. The magnetic sensors may report the presence, direction, rate of change and/or strength of a magnetic field using analog and/or digital signals.

In an example embodiment, the support 280 supports the magnetic sensors 212, 222 and 232 to position them close enough to the magnets 210, 220 and 230, so that the magnetic sensors 212, 222 and 232 can detect the magnetic fields from the magnets 210, 220 and 230 when proximate. The magnets 210, 220 and 230 may be electromagnets or permanent magnets.

The magnetic sensors and the magnets as discussed herein may be used with the mechanical steering system 100 or the fly-by-wire steering system 200 to detect the position of the rack 108 with respect to the pinion 106.

### Other Types of Sensors

In the example embodiments discussed herein, the sensors are described as magnetic sensors that detect the magnetic field of a magnet. The sensors are not limited to being magnetic sensors. Any type of sensor may be used to detect any type of physical phenomenon. For example, instead of using magnets, a light source (e.g., LED) may be used, so instead of using magnetic sensors, photo sensors may be used to detect when the photosensor is positioned across from (e.g., proximate to, adjacent to) a light source. In an embodiment that uses light as the detected physical phenomenon, the light sources and the photosensors may be positioned along the length of the rack 108 and the support 280 for detecting the position of the rack 108 relative to the support 280. In an example embodiment, as best seen in FIG. 10, a plurality of photo sensors C0, R1-R5 and L1-L5 are positioned along the length of the rack 108. A light source S0 is positioned at the central position on the support 280. As the rack 108 moves with respect to the support 280, the different photosensors detect the light from the light source S02 and provide a current through a respective circuit associated with the photosensor. The circuits are not shown. The current from the photosensors may be detected to determine the position of the rack 108 with respect to the support 280. In another example embodiment, additional light sources (e.g., SL1, SL2, SR1, SR2) are positioned on the support 280. The plurality of light sources because current to flow through a plurality of photosensors. Again, the position of the rack 108 relative to the support 280 may be determined by determining which photosensors provide a respective current.

In another example embodiment, the magnets and the sensors may be replaced by electrodes. When two electrodes are proximate to each other, electrodes may make physical contact thereby completing a circuit. Completion of the circuit may be detected, for example by processing circuit 240, thereby indicating which contacts are physically contacting each other. Again, the electrodes may be positioned along the length of the rack 108 and the support 282 provide information regarding the position of the rack 108 relative to the support 280. If there is a gap between the contacts, a spark jumped the gap to complete the circuit.

Any type of physical phenomena with its related sensors and sources may be used to detect the position and movement of the rack 108 relative to the support 280. Mechanicals sensors may also be used. For example, plunger switches may be positioned along the length of the support 280. Holes may be positioned along the length of the rack. When a plunger switch is positioned across a hole the plunger of the switch enters the hole thereby electrically opening the switch and thereby opening the electric circuit associated with the switch. When the plunger switch is not positioned across from a hole, the plunger is pushed into the switch thereby electrically closing the switch and the electric circuit associated with the switch. The opening and closing of circuits may be used to detect the position of the rack 108 with respect to the support 280.

Sensors and sources that detect different physical phenomenon may be used in combination with each other. For example, limit switches, light sources and photosensors, and magnets and magnetic sensors may be used at the same time on rack 108 and/or the support 280. The limit switches would detect the holes, the photosensors would detect the light sources and the magnetic sensors would detect the magnets. The sources and sensors may be placed at any position along the length of the rack 108 and/or to support 280.

### Processing Circuit and Memory

The processing circuit 240 may be embodied by any type of system that performs the functions of the processing circuit 240. Embodiments of the processing circuit may include a microprocessor, a signal processor, a computer, or any combination thereof. The processing circuit 240 may receive signals (e.g., analog, digital) and/or data, for example the data from the steering sensor 260 and the magnetic sensors 212, 222 and 232. The processing circuit 240 may receive signals and/or data via wired or wireless connections. The connections between the processing circuit 240 and the magnetic sensors 212, 222 and 232 are not shown in FIG. 2 for clarity of presentation. The processing circuit 240 may generate signals and/or data for controlling other component of the fly-by-wire steering system 200, such as the actuator 270. The processing circuit 240 may use data received from the steering sensor 260 and/or the magnetic sensors 212, 222 and 232 to determine the signals and/or data for controlling the component of the fly-by-wire steering system 200, for example the actuator 270.

The memory 250 may be any type of suitable memory. The memory 250 may include volatile (e.g., DRAM, SRAM, flash) and non-volatile memory (e.g., ROM, flash, EPROM, PROM, EEPROM). The memory 250 may include a drive (e.g., magnetic, solid-state, optical).

The processing circuit 240 may access the memory 250. The processing circuit 240 may store data in (e.g., write data to) the memory 250. The processing circuit 240 may receive (e.g., read) data from the memory 250. The memory 250 may store a program. The processing circuit 240 may execute the stored program to perform the functions of the fly-by-wire steering system 200. The memory 250 may be integrated into the processing circuit 240.

### Single Sensor, Single Magnet Embodiment

An example embodiment of the fly-by-wire steering system 200 includes the steering sensor 260, the processing circuit 240, the memory 250, the actuator 270, the magnet 230 and the magnetic sensor 232. The magnetic sensor 232 provides the signal 234 in accordance with sensing. When the magnetic sensor 232 is proximate to the magnet 230, the value of the signal 234 is different than when the magnetic sensor 232 is not proximate to the magnet 230. For example, referring to FIGS. 3-9, the magnetic sensor 232 provides a high level (e.g., nonzero, 1) on the signal 234 when the magnetic sensor 232 it positioned proximate to (e.g., across from, close to) the magnet 230. When the magnetic sensor 232 is positioned distal from (e.g., not across from, not close to, away from) the magnet 230, the magnetic sensor 232 provides a low level (e.g., zero) on the signal 234. The same type of signal levels are provided by the magnetic sensors 212 and 222 when they are positioned proximate to and distal from a magnet (e.g., 210, 220, 230).

In the example embodiment that includes only magnetic sensor 232 and one magnet 230, the magnet 230 is positioned at the center (e.g., middle, halfway point) of the rack 108 and the magnetic sensor 232 is positioned at the center of the support 280, as indicated by the arrow 150 in FIG. 3. So, the magnetic sensor 232 provides the signal 234 at the high level only when the center of the rack 108 is centrally positioned as shown in FIG. 3. When the rack 108 is positioned at the central position, the wheels 120 are oriented for straightforward travel of the vehicle. In other words, when the magnetic sensor 232 provides the signal 234 at the high level, the rack 108 is in the central position and the wheels 120 are oriented forward.

The single sensor embodiment may be used to determine when the rack 108 is centrally positioned, but it may not be used to determine the position of the rack 108 when it is not centrally positioned. Further, the single sensor embodiment does not provide information as to the direction of travel of the rack 108.

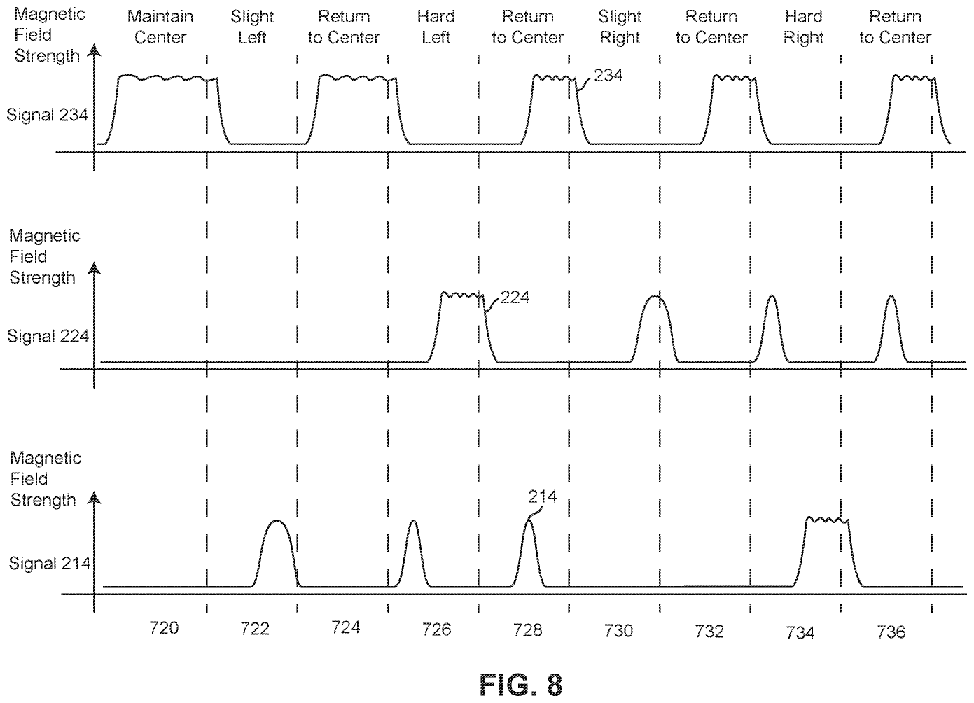

An example of the signal 234 as provided by the magnetic sensor 232 while the steering wheel 102 is positioned to maintain the vehicle traveling in the forward direction is shown in portion 720 of FIG. 8. As the vehicle drives in the forward direction, the terrain over which the wheels 120 travel may cause slight movement in the rack 108. The slight movement of the rack may cause the magnet 230 to move with respect to the magnetic sensor 232. Magnetic field strength of the magnet decreases as a square of the distance from the magnet. So, slight changes in position between the magnet and the magnetic sensor may result in a decrease in the level of the signal (e.g., 214, 224, 234) provided by the magnetic sensor. So, if the wheels 120 cause slight movements in the rack 108, the levels of the signals may also vary slightly. For example, as magnetic sensor 232 moves slightly away from the magnet 230, the level of the signal 234 may decrease. As the magnet 230 moves back into straight alignment with the magnetic sensor 232, the level of the signal 234 returns to its maximum value. When the processing circuit 240 detects the signal 234 at the high level, the processing circuit knows that the rack 108 is centrally positioned. When the processing circuit 240 detects slight variations in the level of the signal 234, the processing circuit 240 knows that the rack 108 is centrally positioned with slight movements to the right or the left.

In an embodiment where the wheels 120 do not affect the positioning of the rack 108, the magnetic sensor 232 may be positioned proximate to the magnet 230 in the central position so the signal 234 remains at the high level without variation.

### Multiple Sensors, Multiple Magnets Embodiment

Another example embodiment of the fly-by-wire steering system 200 includes the steering sensor 260, the processing circuit 240, the memory 250, the actuator 270, the magnets 210, 220 and 230, and the magnetic sensors 212, 222 and 232. The magnetic sensors 212, 222 and 232 provide the signals 214, 224 and 234 respectively in accordance with sensing. As shown in FIGS. 3-7, when the magnetic sensor 212 is proximate to a magnet (e.g., 210, 230), the value of the signal 214 is at the high level. When the magnetic sensor 212 is not proximate to a magnet (e.g., 210, 230), the value of the signal 214 is at the low level. When the magnetic sensor 222 is proximate to a magnet (e.g., 220, 230), the value of the signal 224 is at the high level and when the magnetic sensor 222 is not proximate to a magnet (e.g., 220, 230), the value of the signal 224 is at the low level.

In the multiple magnetic sensors, multiple magnets embodiment, as with the single magnet, single magnetic sensor embodiment discussed above, the magnet 230 is positioned in the center of the rack 108 and the magnetic sensor 232 is positioned in the center of the support 280, so the magnetic sensor 232 provides the signal 234 at the high level only when the rack 108 is centrally positioned. The magnets 210 and 220 are positioned at the opposite ends of the rack 108 to identify the ends of the rack 108.

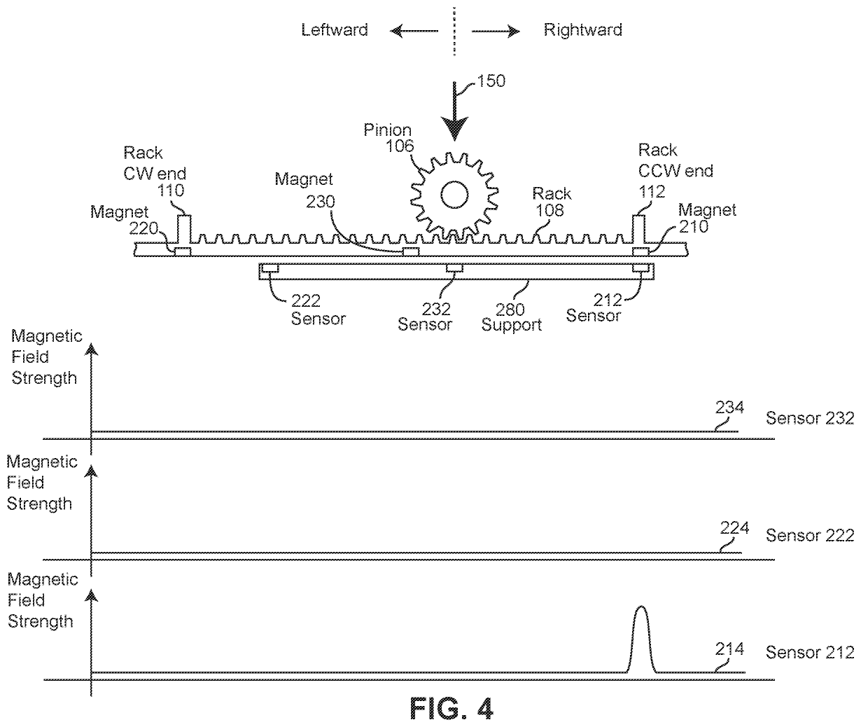

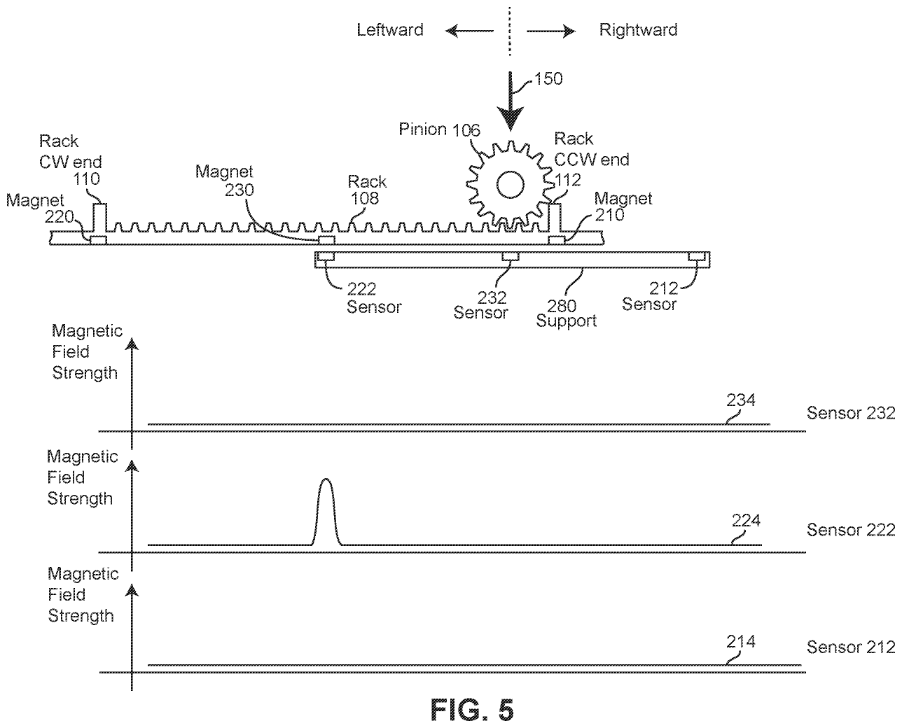

The signals provided by the magnetic sensors 212, 222 and 232 with respect to the movement of the rack 108 are shown in FIGS. 3-7. In the FIG. 3, the rack 108 is centrally positioned, so the magnetic sensor 232 is proximate to the magnet 230 and the signal 234 is at the high level. As the pinion 106 rotates in the counterclockwise direction, from the perspective of the driver (e.g., pinion rotates clockwise in FIGS. 3-7), the rack 108 moves leftward, as shown in FIGS. 4 and 5, so the pinion 106 gets closer to the rack CCW end 112.

As the rack moves leftward, the magnet 230 moves away from the magnetic sensor 232, so the signal 234 goes to the low level. As the rack 108 continues to move leftward, as shown in FIG. 4, the magnet 210 moves to be positioned proximate to the magnetic sensor 212, so the signal 214 is at the high level. As the rack continues to move leftward, the magnet 210 moves away from the magnetic sensor 212, so the signal 214 returns to the low level.

As the rack 108 continues to move leftward, the in FIG. 5, the magnet 230 moves to be positioned proximate to the magnetic sensor 222. At this position, the pinion 106 is positioned at the rack CCW end 112 and can move no further. Further, the magnet 230 has been brought into position proximate to the magnetic sensor 222. While the magnet 230 is positioned proximate to the magnetic sensor 222, the signal 224 is at the high level.

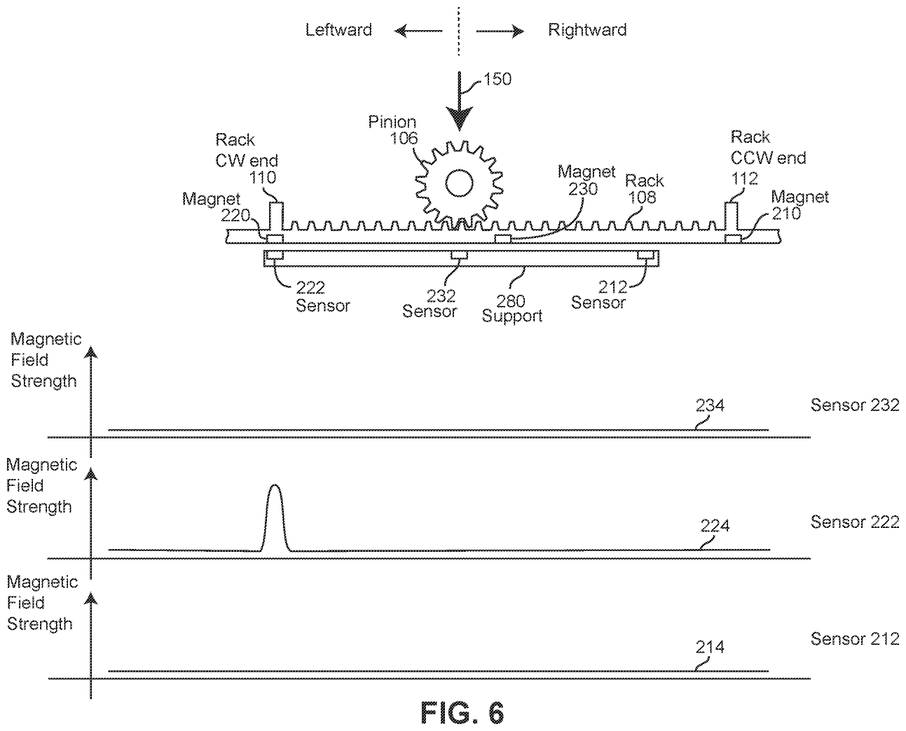

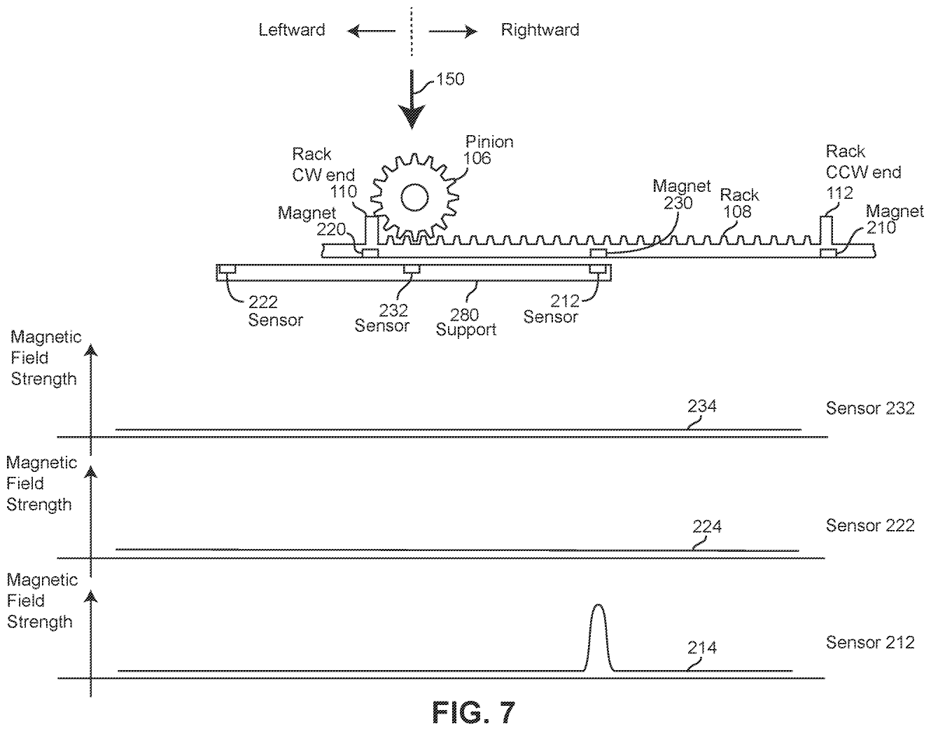

In the FIG. 6, the driver has rotated the steering wheel clockwise, from the perspective of the driver, from the central position, so the rack 108 has moved rightward from the central position as shown in FIGS. 6 and 7. As the rack moves rightward, the magnet from the central position, the magnet 230 moves away from the magnetic sensor 232, so the signal 234 goes to the low level. As the rack continues to move rightward, as shown in FIG. 6, the magnet 220 moves to be positioned proximate to the magnetic sensor 222, so the signal 224 is at the high level. As the rack continues to move rightward, the magnet 220 moves away from the magnetic sensor 222, so the signal 224 returns to the low level.

As the rack 108 continues to move rightward, as shown in FIG. 7, the magnet 230 moves to be positioned proximate to the magnetic sensor 212. At this position, the pinion 106 is positioned at the rack CW end 110 and can move no further. Further, the magnet 230 has been brought into position proximate to the magnetic sensor 212. While the magnet 230 is positioned proximate to the magnetic sensor 212, the signal 214 is at the high level.

In operation, as the driver rotates the steering wheel 102 clockwise and counterclockwise, from the perspective of the driver, the steering sensor 260 translates the movements of the steering wheel into data which is provided to the processing circuit 240. The processing circuit 240 uses the data from the steering sensor 260 to control the actuator 270.

As the steering wheel 102 is rotated in the clockwise direction from the perspective of the driver, the processing circuit 240 controls the actuator 270 to rotate the pinion 106 in the clockwise direction, from the perspective of the driver, so that the rack 108 moves rightward with respect to FIGS. 3-7. When the rack 108 has moved to its extreme right most position, the pinion 106 is positioned at the rack CW end 110 and the magnetic sensor 212 is positioned proximate to the magnet 230. The high level on the signal 214 informs the processing circuit 240 that the rack 108 cannot move further in the rightward direction.

As the steering wheel 102 is rotated in the counterclockwise direction from the perspective of the driver, the processing circuit 240 controls the actuator 270 to rotate the pinion 106 in the counterclockwise direction, from the perspective of the driver. Rotation of the pinion 106 in the counterclockwise direction from the perspective of the driver moves the rack 108 leftward as shown in FIGS. 3-7. When the rack 108 has moved to its extreme leftmost position, the pinion 106 is positioned at the rack CCW end 112 and the magnetic sensor 222 is positioned proximate to the magnet 230. The high level of the signal 224 informs the processing circuit 240 that the rack 108 cannot move further in the leftward direction.

### Data From Magnetic Sensors

The signals 214, 224 and 234 can be used to determine the position of the rack 108, as discussed above, in addition to the direction of travel of the rack 108 (e.g., leftward, rightward). The diagram of FIG. 8, shows the sequence of the levels (e.g., high, low) for the signals 214, 224 and 234 as the steering wheel is turned. In portion 720, the steering wheel is maintained in the central position so that the rack 108 is also centrally positioned. Because the rack 108 is held at the central position, the magnetic sensor 232 is positioned proximate to the magnet 230. The slight variations in the position of the rack 108 may result in slight variations in the value of the signal 234 as discussed above.

In portion 722, the driver is rotating the steering wheel 102 counterclockwise, from the perspective of the driver, to make a slight left turn. A slight left turn moves the rack 108 in the leftward direction, as shown in FIG. 4, thereby bringing the magnetic sensor 212 proximate to the magnet 210. In the portion 722, the signal 234 goes to the low level as the rack 108 moves the magnet 230 away from the magnetic sensor 232 while the signal 214 goes to the high level as the magnet 210 is moved into position proximate to the magnetic sensor 212.

The portion 724 shows the steering wheel 102 being returned from the slight left turn to the center position. As the rack 108 moves from the slight left turn back to the central position, the signal 214 goes to the low level as the magnet 210 moves away the magnetic sensor 212 followed by the signal 234 going to the high level as the magnet 230 moves to be proximate to the magnetic sensor 232 as shown in FIG. 3.

In portion 726, the driver rotates the steering wheel 102 in the counterclockwise direction, from the perspective of the driver, to make a hard left turn. As the magnet 230 moves away from the magnetic sensor 232, the signal 234 goes to the low level. As the rack 108 continues to move leftward, referring to FIG. 4, the signal 214 goes to the high level then the low level as the magnet 210 moves proximate to magnetic sensor 212 and then away from the magnetic sensor 212. As the rack continues to move leftward, referring to FIG. 5, the magnet 230 moves to be positioned proximate to the magnetic sensor 222, so the signal 224 goes to the high level. As discussed above, the position shown in FIG. 5 is a leftmost position of the rack 108. Assume, since the drivers is making a hard left turn that the driver holds the steering wheel 102 at its maximum counterclockwise position for a period of time. The signal 224 remain at the high level with possible slight variations as discussed above.

In portion 728, the driver turns the steering wheel 102 clockwise to return to center. As the steering wheel 102 is turned clockwise, from the perspective of the driver, the magnet 230 moves away from the magnetic sensor 222, so the signal 224 goes to the low level. At the rack 108 continues to move rightward, the magnet 210 is brought momentarily proximate to magnetic sensor 212, so the signal 214 momentarily goes to the high level. As the rack 108 continues to move rightward, the magnet 210 moves away from the magnetic sensor 212, so the value of the signal 214 returns to the low level. As the steering wheel 102 continues to rotate in the clockwise direction, the rack 108 continues to move to the right thereby bringing the magnet 230 proximate to the magnetic sensor 232, so the signal 234 goes to the high level. As the steering wheel 102, and the rack 108 are held in the central position, slight movements in the wheels 120 may move the magnet 230 with respect to the magnetic sensor 232, so there may be slight variations in the signal 234 as shown in portion 728 and as discussed above.

The portion 730 shows the sequence of signals for a slight right-hand turn. As the driver rotates the steering wheel 102 clockwise, from the perspective of the driver, the pinion 106 rotates clockwise, also from the perspective of the driver, to move the rack 108 in the rightward direction as shown in FIG. 6. As the rack 108 moves to the right, the magnet 230 moves away from the magnetic sensor 232, so the signal 234 goes to the low level. As a steering wheel 102 continues to rotate clockwise, the rack 108 continues to move to the right to position the magnet 220 proximate to the magnetic sensor 222 as shown in FIG. 6. Because the magnet 220 is positioned proximate to the magnetic sensor 222, the signal 224 goes to the high level. Assume that the driver holds the steering wheel 102 in that position for a period of time. The signal 224 will remain at the high level for the period of time, possibly with slight variations as discussed above.

In portion 732, the driver returns the steering wheel from the slight right-hand turn to the center position. To return to the center position, the driver rotates a steering wheel 102 in the counterclockwise direction. As the steering wheel 102 is rotated in the counterclockwise direction, from the perspective of the driver, the rack 108 moves leftward with respect to FIGS. 3-7. At the rack 108 moves leftward, the signal 224 goes to the low level as the magnet 220 moves away from the magnetic sensor 222. The rack 108 continues to move leftward until the magnet 230 is brought proximate to the magnetic sensor 232 as shown in FIG. 3. During portion 732, the driver maintains the steering wheel 102 in the center position, so the magnet 230 remains proximate to the magnetic sensor 232 and the signal 234 remains at a high level, with possible slight variations as discussed above.

In portion 734, the driver makes a hard right turn. As a driver rotates the steering wheel 102 in the clockwise direction, the pinion 106 moves the rack 108 rightward. As the rack 108 moves rightward, the magnet 230 moves away from the magnetic sensor 232, so the signal 234 goes to the low level. Continued movement of the rack 108 rightward brings the magnet 220 proximate to the magnetic sensor 222, as shown in FIG. 6, and then away from the magnetic sensor 222, so the signal 224 momentarily goes to the high level. Continued movement of the rack 108 to the right, brings the magnet 230 proximate to the magnetic sensor 212, as shown in FIG. 7, so the signal 214 goes to the high level. The position shown in FIG. 7 is the rightmost position of the rack 108. As long as the driver holds the steering wheel 102 in the most clockwise position, the magnet 230 remains positioned proximate to the magnetic sensor 212, so the value of the signal 214 remains at the high level, possibly with small variations as discussed above.

In portion 736, the driver begins to return the steering wheel 102 from the rightmost position to the center position. As the driver turns the steering wheel 102 counterclockwise, the rack 108 moves leftward. As the rack 108 moves leftward, the magnet 230 moves away from the magnetic sensor 212, so the signal 214 goes to the low level. As a rack 108 continues to move leftward, the magnet 220 is brought proximate to magnetic sensor 222, as shown in FIG. 6, so the signal 224 goes to the high level. At the rack 108 continues to move leftward, the magnet 220 moves away from the magnetic sensor 222 so the signal 224 goes to the low level. As the rack 108 moves to the central position, the magnet 230 moves proximate to the magnetic sensor 232, as shown in FIG. 3, so the signal 234 goes to the high level. As the steering wheel 102 and the rack 108 remain in the central position, the signal 234 remains at level high level, possibly with slight variations due to slight movements in the position of the rack 108 as discussed above.

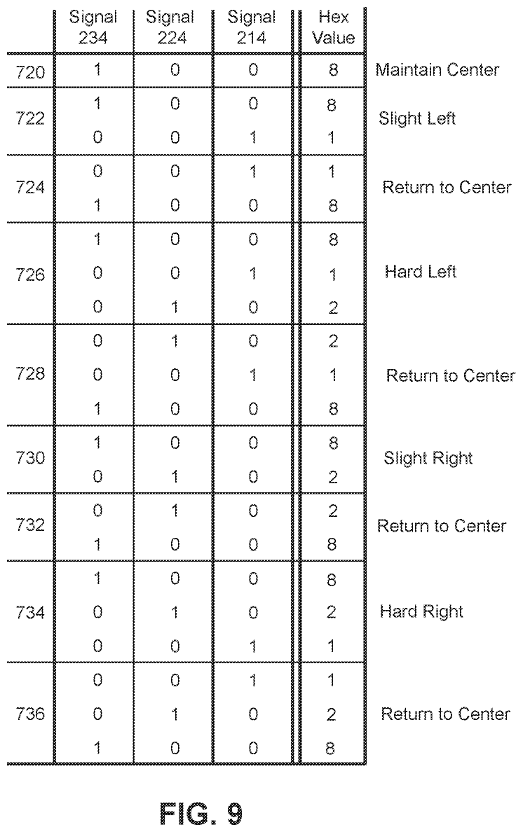

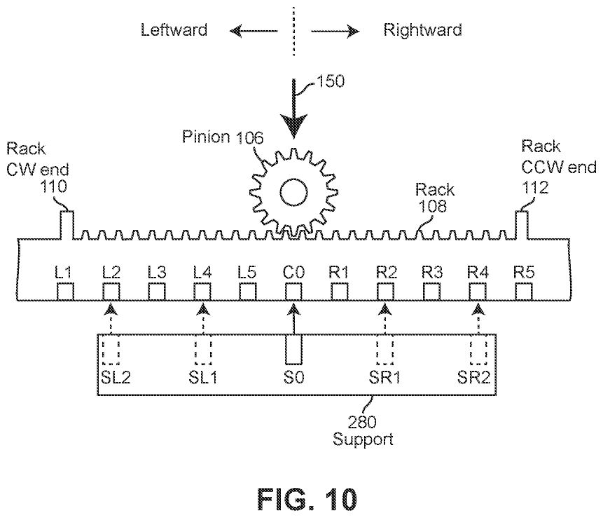

The signals 214, 224 and 234 may be interpreted as digital values. The sequence of digital values clearly show the direction of movement of the rack 108 and therefore the direction of rotation of the steering wheel 102. The digital values of the signals 214, 224 and 234 for the portions of FIG. 8 are shown in FIG. 9. Depending on the road and how the steering wheel 102 is turned, the output level of the magnetic sensors 212, 222, 232 may be at the low level most of the time, so in interpreting the signals 214, 224 and 234 as digital values, the times when at least one signal 214, 224 and 234 is at the high level are identified. Only the digital values where at least one of the signals 214, 224 and 234 is at the high level are considered. The hex value provided in FIG. 9 uses the signal 234 as the most significant digit, the signal 224 as the next most significant digit and the signal 214 as the least significant digit.

If the signals 234, 224 and 214 are considered as digital values in the format of a hexadecimal (e.g., hex) number, the steering wheel 102 and the rack 108 are positioned in their center most positions, portion 720 of FIG. 8 and FIG. 3, when the hex value of the signals is 0x8, which means that the signal 234 is at the high level while the signals 224 and 214 are at the low level.

In portion 722, as the steering wheel 102 is turn from the center position counterclockwise, to steer the vehicle to the left, the hex value goes from 0x8 to 0x1.

In portion 724, as the steering wheel 102 is returned to center from the slight left turn, the hex value goes from 0x1 to 0x8.

In portion 726, the steering wheel 102 is turned from the center position hard counterclockwise for a hard left turn that takes the steering wheel 102 and the rack 108 to their most extreme counterclockwise positions. As the steering wheel 102 is turned hard left, the hex value goes from 0x8 to 0x1 to 0x2. As long as the steering wheel 102 is held in the hard counterclockwise position, the rack 108 is positioned so that the pinion 106 is at the rack CCW end 112 of the rack 108, and the hex value will remain at 0x2.

The portion 728 shows the return to center from a hard left turn. As the steering wheel 102 and the pinion 106 rotate clockwise, the hex value goes from 0x2 to 0x1 then to 0x8 once the rack 108 and the steering wheel 102 reach the central position. As discussed above, while the steering wheel 102 and the rack 108 are held in the central position, the hex value will remain 0x8.

The portion 730 shows the hex value for a slight right turn. As the wheel is rotated clockwise out of the center position, the hex value goes from 0x8 to 0x2.

In portion 732, the steering wheel 102 is returned to center from a slight right turn. As the steering wheel 102 is rotated in the counterclockwise direction, hex value goes from 0x2 to 0x8 when the steering wheel 102 and rack 108 reaches the central position. As discussed above, the hex value will remain at 0x8 as long as the steering wheel 102 and the rack 108 are in the central position.

In portion 734, the steering wheel 102 is rotated clockwise in a hard right turn. As the steering will is rotated clockwise, the pinion 106 also rotates clockwise to move the rack 108 to the right as shown in FIGS. 6 and 7. As the steering wheel 102 rotates clockwise, the hex value goes from 0x8 to 0x2 then to 0x1. The hex value will remain at 0x1 as long as the steering wheel 102 is held in the most clockwise position.

In portion 736, the steering wheel 102 and the rack 108 move from the rightmost position to the central position. As a steering wheel 102 is rotated counterclockwise, the hex value goes from 0x1 to 0x2 to 0x8.

The table of FIG. 9 provides the understanding that the magnetic sensor 232 provides a signal at the high level while the rack is positioned at the central position, refer to FIG. 3. The magnetic sensor 232 provides a signal at the low level while the rack is positioned at all other positions.

The magnetic sensor 222 provides a signal at the high-level while the rack is positioned at a first rightward position, refer to FIG. 6, and while the rack is positioned at a leftmost position, refer to FIG. 5. The magnetic sensor 232 provides a signal at the low level while the rack is positioned at all other positions.

The magnetic sensor 212 provides a signal of the high-level while the rack is positioned at a first leftward position, refer to FIG. 4, and while the rack is positioned at a rightmost position, refer to FIG. 7. The magnetic sensor 232 provides a signal at the low level while the rack is positioned at all other positions.

### Calibration

As discussed above, in the fly-by-wire steering system 200 discussed herein there is no physical connection between the steering wheel 102 and the pinion 106 or the rack 108. Some of the examples discussed above state that the steering wheel may be held in the central, the most counterclockwise or the clockwise position; however, in operation there may be no physical structures that limit the turning of the steering wheel 102, so there would be no way for the driver to detect the central, the rightmost or the leftmost positions of the steering wheel. For example, if the driver to make a hard right turn, even though movement of the rack 108 would be limited by the pinion 106 contacting the rack CW end 110, the steering wheel 102 could continue to be turned clockwise even though the rack 108 has hit a hard physical limit. Since there is no physical structure that establishes the central position for the steering wheel 102, the data from the magnetic sensors 212, 222 and 232 may be used to identify when the rack 108 and therefore the steering wheel 102 are in the central position.

For example, as long as the magnetic sensor 232 is positioned proximate to the magnet 230, the rack 108 is in the central position. As a result, the steering wheel 102 is also in the central position whatever position it is currently in. So, the information from the magnetic sensors 212, 222 and 232 may be used to calibrate and identify the position of the steering wheel 102, and in particular when the steering wheel 102 is in the central position. The same information may be used to calibrate the steering sensor 260 so that the steering sensor 260 knows when the steering wheel is in the central position or at the counterclockwise or clockwise limits.

Calibration of the steering sensor 260 may be accomplished by the processing circuit 240 detecting the position of the rack 108 and reporting the position to the steering sensor 260. For example, when the processing circuit 240 detects that the rack 108 is positioned at the central position (refer to FIG. 3), the processing circuit 240 informs the steering sensor 260 that the steering wheel 102 is positioned at its central position. When the processing circuit detects that the rack 108 is positioned at its leftmost (refer to FIG. 5) or rightmost position (refer to FIG. 7), the processing circuit 240 informs the steering sensor 260 that the steering wheel has reached its maximum counterclockwise rotation (e.g., maximum left turn) or its maximum clockwise rotation (e.g., maximum right turn) respectively.

The steering sensor 260 may mimic a mechanical steering system by including structure that can stop the further rotation of the steering wheel 102 when the signals from the magnetic sensors 212, 222 and/or 232 indicate that the rack 108 is at its leftmost (refer to FIG. 5) or rightmost (refer to FIG. 7) limits. Operation of the structures may be controlled by the processing circuit 240. The structures may stop rotation of the steering wheel 102 in one direction (e.g., clockwise), but not in the other direction (e.g., counterclockwise) or vice a versa. Structures for stopping the rotation of the steering wheel 102 may include mechanical structures, electromechanical structures (e.g., solenoid), electrical structures (e.g., electromagnet) and/or electronic structures.

The processing circuit 240 may determine from the signals from the magnetic sensors 212, 222 and/or 232 that the rack has reached its leftmost (e.g., signal 224=1) or rightmost position (e.g., signal 214=1). The processing circuit 240, in accordance with the signals, may control the steering sensor 260 to stop rotation of the steering wheel 102 in its current direction of rotation. For example, as the steering wheel 102 is rotated to the right, clockwise, the rack 108 moves rightward until the pinion is positioned at the rack CW end 110 which means that the rack 108 is at its rightmost position (see FIG. 7). When the rack 108 reaches its rightmost position, the processing circuit 240 may control the steering sensor 260 to stop further clockwise rotation of the steering wheel 102. As the steering wheel 102 is rotated to the left, counterclockwise, the rack 108 moves leftward until the pinion is positioned at the rack CCW end 112 which means that the rack 108 is at its leftmost position (see FIG. 5). When the rack 108 reaches its leftmost position, the processing circuit 240 may control the steering sensor 260 to stop further counterclockwise rotation of the steering wheel 102.

The steering sensor 260 may be continuously calibrated during normal operation. For example, each time the signal 224 is at the high level (e.g., hex value=0x2), the processing circuit 240 may inform the steering sensor 260 that the rack 108 has moved as far to the left (e.g., counterclockwise) as possible (e.g., pinion 106 in contact with the rack CCW end 112), so further counterclockwise rotation of the steering wheel 102 will not result in a further turning of the wheels 120. Each time the signal 214 is at the high level (e.g., hex value=0x1), the processing circuit 240 may inform the steering sensor 260 that the rack 108 has moved as far to the right (e.g., clockwise) as possible, so further clockwise rotation of the steering wheel 102 will not result in further turning of the wheels 120. Further, each time the signal 234 is at the high level (e.g., hex value=0x8), the processing circuit 240 may inform the steering sensor 260 that the rack 108, and therefore the steering wheel 102, are in the central position. Each time the steering wheel is turned counterclockwise or clockwise from the central position, the processing circuit 240 may monitor the signals 214, 224 and 234 to determine when the rack 108 and therefore the steering wheel 102 has returned to the center position.

Each time the vehicle is turned off or in the event of a loss of power in the vehicle, the signals 214, 224 and 234 may be used to initialize the steering sensor 260 and/or the actuator 270 on restoration of power to the vehicle. When the vehicle transitions from a powered-down state to a powered state, the processing circuit 240 monitors the signals 214, 224 and 234 to detect the position of the rack 108 and/or its movement to the left or to the right. The processing circuit 240 monitors the signals 214, 224 and 234 to detect when the signal 234 goes to the high level (e.g., hex value =8) which indicates that the rack 108 and therefore the steering wheel 102 are in the central position. The processing circuit 240 also monitors the sequence of the signals 214, 224 and 234 (e.g., hex value sequence 0x1 to 0x2 to 0x8, hex value sequence 0x2 to 0x1 to 0x8) to detect the direction of motion of the rack 108.

After the processing circuit 240 has determined the position and/or the direction of movement of the rack 108, the processing circuit may initialize and/or calibrate the steering sensor 260 and/or the actuator 270. After calibration, the processing circuit 240 monitor the signals 214, 224 and 234 and the steering sensor 260 to operate the fly-by-wire steering system 200 as discussed above.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A fly-by-wire steering system for a vehicle, the fly-by-wire steering system comprising:
a processing circuit;
a pinion;
a rack, the rack moves responsive to a rotation of the pinion;
a support, the support is adapted to couple to the vehicle, the support is stationary, the rack moves with respect to the support;
a plurality of magnetic sensors adapted to couple to the support and positioned along a first length of the support; and
a plurality of magnets adapted to couple to the rack and positioned along a second length of the rack; wherein:
as the rack moves, the magnets move with respect to the magnetic sensors;
each magnetic sensor provides a respective signal while a magnet is positioned proximate to the magnetic sensor;
the processing circuit receives the respective signals from the magnetic sensors; and
in accordance with the respective signals from the magnetic sensors, the processing circuit determines a position of the rack and a direction of movement of the rack.

2. The fly-by-wire steering system of claim 1 wherein in accordance with the signals from the magnetic sensors, the processing circuit further determines a rate of movement of the rack.

3. The fly-by-wire steering system of claim 1 wherein the plurality of magnets comprises three magnets, a first magnet positioned at a midpoint of the rack, a second magnet positioned at or near a first end of the rack and a third magnet positioned at or near a second end of the rack.

4. The fly-by-wire steering system of claim 2 wherein the plurality of magnetic sensors comprises three magnetic sensors, a first magnetic sensor positioned at a midpoint of the support, a second magnetic sensor positioned at or near a first end of the support and a third magnetic sensor positioned at or near a second end of the support.

5. The fly-by-wire steering system of claim 4 wherein:
the first magnetic sensor provides a first signal at a high level while the rack is positioned at a central position;
the second magnetic sensor provides a second signal at the high level while the rack is positioned at a first rightward position and a leftmost position; and
the third magnetic sensor provides a third signal at the high level while the rack is positioned at a first leftward position and a rightmost position.

6. The fly-by-wire steering system of claim 5 wherein:
the first magnetic sensor provides the first signal at a low level while the rack is positioned at all other positions other than the central position;
the second magnetic sensor provides the second signal at the low level while the rack is positioned at all other positions other than the first rightward position and the leftmost position; and
the third magnetic sensor provides the third signal at the low level while the rack is positioned at all other positions other than the first leftward position and the rightmost position.

7. A fly-by-wire steering system for a vehicle, the fly-by-wire steering system comprising:
a processing circuit;
a steering wheel;
a steering sensor for detecting a rotation of the steering wheel, the steering sensor provides a data to the processing circuit responsive to detecting the rotation of the steering wheel;
a pinion;
an actuator, the pinion coupled to the actuator, the processing circuit controls the actuator to rotate the pinion responsive to the data;
a rack, the rack moves responsive to the rotation of the pinion;
a support, the support is adapted to couple to the vehicle, the support is stationary, the rack moves with respect to the support;
a plurality of magnetic sensors adapted to couple to the support and positioned along a first length of the support; and
a plurality of magnets adapted to couple to the rack and positioned along a second length of the rack; wherein:
as the rack moves, the magnets move with respect to the magnetic sensors;
each magnetic sensor provides a respective signal while a magnet is positioned proximate to the magnetic sensor;
the processing circuit receives the respective signals from the magnetic sensors; and
in accordance with the respective signals from the magnetic sensors, the processing circuit determines a position of the rack and a direction of movement of the rack.

8. The fly-by-wire steering system of claim 7 wherein in accordance with the signals from the magnetic sensors, the processing circuit further determines a rate of movement of the rack.

9. The fly-by-wire steering system of claim 7 wherein responsive to the steering sensor detecting a clockwise rotation of the steering wheel, the processing circuit controls the actuator to rotate the pinion to move the rack in a rightward direction.

10. The fly-by-wire steering system of claim 7 wherein responsive to the steering sensor detecting a counterclockwise rotation of the steering wheel, the processing circuit controls the actuator to rotate the pinion to move the rack in a leftward direction.

11. The fly-by-wire steering system of claim 7 wherein in accordance with the processing circuit determining that the rack is positioned in a central position, the processing circuit informs the steering sensor that the steering wheel is positioned at its central position.

12. The fly-by-wire steering system of claim 7 wherein in accordance with the processing circuit determining that the rack is positioned at a leftmost position, the processing circuit informs the steering sensor that the steering wheel has reached a maximum counterclockwise rotation.

13. The fly-by-wire steering system of claim 7 wherein in accordance with the processing circuit determining that the rack is positioned at a leftmost position, the processing circuit informs the steering sensor that the steering wheel has reached a maximum clockwise rotation.

14. The fly-by-wire steering system of claim 7 wherein the steering sensor further comprises a structure that stops rotation of the steering wheel when the rack reaches a leftmost or a rightmost position.

15. The fly-by-wire steering system of claim 7 wherein:
the steering sensor further comprises a structure that stops rotation of the steering wheel;
responsive to the processing circuit detecting that the rack is positioned at its rightmost position, the processing circuit controls the steering sensor to stop further clockwise rotation of the steering wheel; and
responsive to the processing circuit detecting that the rack is positioned at its leftmost position, the processing circuit controls the steering sensor to stop further counterclockwise rotation of the steering wheel.

16. The fly-by-wire steering system of claim 7 wherein the plurality of magnets comprises three magnets, a first magnet positioned at a midpoint of the rack, a second magnet positioned at or near a first end of the rack and a third magnet positioned at or near a second end of the rack.

17. The fly-by-wire steering system of claim 16 wherein the plurality of magnetic sensors comprises three magnetic sensors, a first magnetic sensor positioned at a midpoint of the support, a second magnetic sensor positioned at or near a first end of the support and a third magnetic sensor positioned at or near a second end of the support.

18. A fly-by-wire steering system for a vehicle, the fly-by-wire steering system comprising:
a processing circuit;
a steering wheel;
a steering sensor for detecting a rotation of the steering wheel, the steering sensor provides a data to the processing circuit responsive detecting to the rotation of the steering wheel;
a pinion;
an actuator, the pinion coupled to the actuator, the processing circuit controls the actuator to rotate the pinion responsive to the data;
a rack, the rack moves responsive to the rotation of the pinion;
a support, the support is adapted to be coupled to the vehicle, the support is stationary, the rack moves with respect to the support;
a first magnetic sensor, a second magnetic sensor and a third magnetic sensor, each magnetic sensor adapted to couple to the support, the first magnetic sensor positioned at a midpoint of the support, the second magnetic sensor positioned at or near a first end of the support and the third magnetic sensor positioned at or near a second end of the support;
a first magnet, a second magnet in a third magnet, each magnet adapted couple to the rack, the first magnet positioned at a midpoint of the rack, the second magnet positioned at or near a first end of the rack and the third magnet positioned at or near a second end of the rack; wherein:
as the rack moves, the first, second and third magnets move with respect to the first, second and third magnetic sensors;
each magnetic sensor provides a respective signal while a magnet is positioned proximate to the magnetic sensor;
the processing circuit receives the respective signals from the magnetic sensors; and
in accordance with the respective signals from the magnetic sensors, the processing circuit determines a position of the rack and a direction of movement of the rack.
